(19) United States
(12) Patent Application Publication
(10) Pub. No.: US 2026/0072139 A1
(43) Pub. Date: Mar. 12, 2026

(54) Portable Repositioning Evidence Support Stand (PRESS)

(71) Applicant: Federal Bureau of Investigation, Washington, DC (US)

(72) Inventors: Jennifer Kenyon, State College, PA (US); Claire Blaisdell, Richmond Hill, GA (US); Bill Denman, Stafford, VA (US); Michael Martin, Fredericksburg, VA (US)

(73) Assignee: Federal Bureau of Investigation, Washington, DC (US)

(21) Appl. No.: 18/828,116

(22) Filed: Sep. 9, 2024

(51) Int. Cl. G01S 7/481; G01S 7/497; G01S 17/894

(52) U.S. Cl. CPC G01S 7/4817; G01S 7/497; G01S 17/894

(57) ABSTRACT

A portable repositioning evidence support stand for supporting forensic evidence primarily for 3D scanning applications. The evidence support stand features a base plate containing a number of mounting apertures, a number of support members, and a number of fasteners. A method for adjusting support of a piece of forensic evidence for 3D scanning, featuring: positioning a plurality of support members of an evidence support stand into a predetermined position, adjusting the height of each support member, securing each support member to the base plate with a fastener, and providing the piece of forensic evidence to bumper pads on the support members.

### STATEMENT OF GOVERNMENT SUPPORT

The United States Government has rights in this invention pursuant to the employer-employee relationship of the Government to the inventors as Federal Bureau of Investigation employees and site-support contractors at the Federal Bureau of Investigation, Laboratory Division (D-07), FRS, OPU, MADP.

### FIELD OF THE INVENTION

Embodiments relate to support stands for forensic evidence examination. More specifically, embodiments describe a configurable evidence support stand primarily for 3D scanning applications that accommodates a variety of shapes of forensic evidence, reduces margin of error during the 3D scanning process, does not damage the forensic evidence, and is easily sanitized between uses, compared to supports disclosed in the prior art, and a method for adjusting support of a piece of forensic evidence for 3D scanning.

### BACKGROUND

Human remains, including craniums and mandibles, are often 3D scanned for research and investigative purposes, particularly in scientific, archaeological, and forensic evidence analysis applications. Traditionally, a cork ring has been used to support a cranium, while other skeletal remains have been placed directly on a flat surface for 3D scanning. However, this method consequently requires multiple scans of the forensic evidence to acquire data that is obscured or topologically associated with the remains by the cork ring or the flat surface. Further, cork rings break down with repeated sanitization using water and alcohol. Prior art also includes hands free stands which involve clamps, however such clamps can damage the forensic evidence where they interface. Such clamps also become topologically associated with the remains in the 3D scans. Likewise, taxidermy skull supports also exist in the prior art, however they are designed for permanent skull mounting and often destroy portions of the bone. At bottom, a need exists in the art for a configurable forensic evidence support stand that accommodates a variety of shapes of forensic evidence, reduces margin of error during the 3D scanning process, does not damage the forensic evidence, and is easily sanitized between uses.

One tool that is commonly used in the 3D scanning process to enhance efficiency is a 3D scanning turntable, such as the Faro 8 Axis. The Faro 8 Axis is a turntable that rotates with an established origin, ensuring that a full rotation of the remains can be scanned within one setting, and thus reduces errors to a degree. However, the Faro 8 Axis cannot give access to the underside of the remains that sit on the turntable surface, necessitating another scan session after the remains is “flipped” upside-down, increasing the margin of error between 3D scans.

Embodiments of the invented evidence support stand described herein improve the efficiency and improve the accuracy of the 3D scanning process. In an embodiment, the invention comprises a base with supports, wherein the supports stably elevate the forensic evidence off the surface of a 3D scanning turntable, such that the forensic evidence can be scanned in one session without having to reposition or flip the forensic evidence over. In an embodiment, the number and placement of the supports are adjustable and make the support stand flexible and individualized to accommodate a variety of types of, and multiple sizes of forensic evidence. In an embodiment, the supports comprise a material that does not topologically associate with the forensic evidence during the 3D scanning process. In an embodiment, the base and supports comprise a material that is easily sterilized between contacts with different sets of forensic evidence. In an embodiment, the evidence support stand is configurable for other forms of evidence that are not skeletal remains, including firearms. In embodiments, the evidence support stand is a stand-alone tool that configured to be positioned on a level or non-level surface. In embodiments, the evidence support stand is configured to be secured to a 3D scanning turntable or any other base allowing for a bolt connection.

A need exists in the art for a configurable evidence support stand that reduces the margin of error when 3D scanning skeletal remains or other pieces of forensic evidence that overcomes the disadvantages of the prior art. The novel apparatus, method, and principles of operation are further discussed in the following description.

### SUMMARY

Embodiments of the invention provide a configurable forensic evidence support stand, primarily for 3D scanning applications on a turntable, that elevates pieces of forensic evidence and reduces margins of error during the 3D scanning process. Embodiments of the evidence support stand comprise: a base plate comprising a thickness extending between a depending surface and a superior surface, wherein the base plate further comprises a plurality of mounting apertures defined through the thickness of the base plate; a plurality of fasteners, each fastener configured to slide within a mounting aperture; and a plurality of support members, wherein each support member extends substantially perpendicularly from the base plate, and wherein the support members are secured to the base plate by a fastener, wherein the fastener extends through the base plate from its depending surface through a mounting aperture, wherein the support members have a height comprising a distance the support members extend from the superior surface of the base plate, and wherein the positions of the support members are configured to be adjusted by sliding a fastener within a corresponding mounting aperture, thereby allowing the plurality of support members to precisely accommodate and support different sizes of pieces of forensic evidence.

The invention further provides a method for adjusting support of a piece of forensic evidence for 3D scanning comprising the steps of: positioning a plurality of support members of an evidence support stand into a predetermined position, wherein the evidence support stand comprises: a base plate comprising a thickness extending between a depending surface and a superior surface, wherein the base plate further comprises a plurality of mounting apertures defined through the thickness of the base plate, and wherein each support member extends substantially perpendicularly from the base plate, wherein each support member comprises a body with a first end and a second end, wherein the first end comprises an aperture configured to receive a fastener extending from the depending surface of the base plate through a mounting aperture, and wherein the second end comprises a bumper pad thereon; adjusting a height of each support member, wherein the height comprises a distance the support members extend from the superior surface of the base plate; securing each support member to the base plate; and providing the piece of forensic evidence to the bumper pads on the plurality of support members.

### BRIEF DESCRIPTION OF THE DRAWINGS

The invention together with the above and other objects and advantages will be best understood from the following detailed description of the preferred embodiment of the invention shown in the accompanying drawings, wherein:

FIG. 1 is a perspective view of an exemplary embodiment of a portable repositioning evidence support stand, in accordance with the features of the present invention;

FIG. 2 is a top view of an exemplary embodiment of a base plate, in accordance with the features of the present invention;

FIG. 3 is a side view of an exemplary embodiment of a support member, in accordance with the features of the present invention;

FIG. 4 is a side view of an exemplary embodiment of a base plate with a plurality of support members and a plurality of fasteners affixed thereto, in accordance with the features of the present invention;

FIG. 5 is a side view of an alternative exemplary embodiment of a support member, in accordance with the features of the present invention

FIG. 6 is an exemplary embodiment of a portable repositioning evidence support stand in use, in accordance with the features of the present invention;

FIG. 7 is an alternative exemplary embodiment of a portable repositioning evidence support stand in use, in accordance with the features of the present invention;

FIG. 8 is a further alternative exemplary embodiment of a portable repositioning evidence support stand in use, in accordance with the features of the present invention; and

FIG. 9 is a flowchart of a method for adjusting support of a piece of forensic evidence for 3D scanning, in accordance with the features of the present invention.

### DETAILED DESCRIPTION

The foregoing summary, as well as the following detailed description of certain embodiments of the present invention, will be better understood when read in conjunction with the appended drawings.

The following detailed description should be read with reference to the drawings in which similar elements in different drawings are numbered the same. The drawings, which are not necessarily to scale, depict illustrative embodiments and are not intended to limit the scope of the invention.

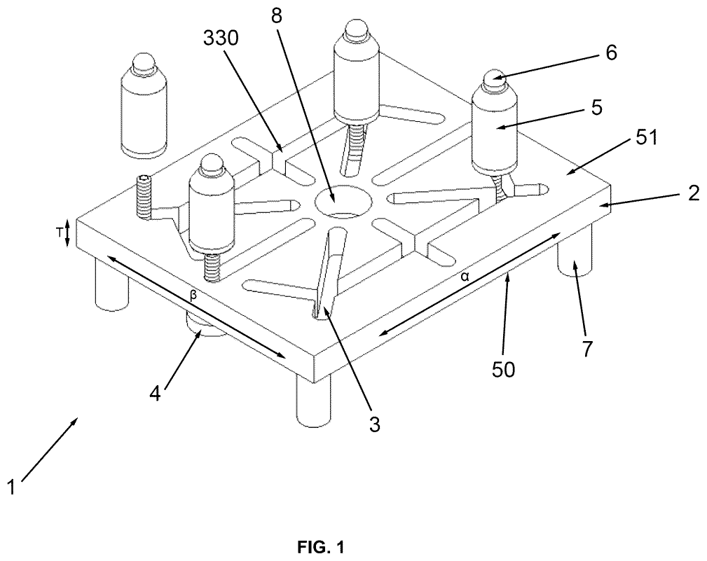

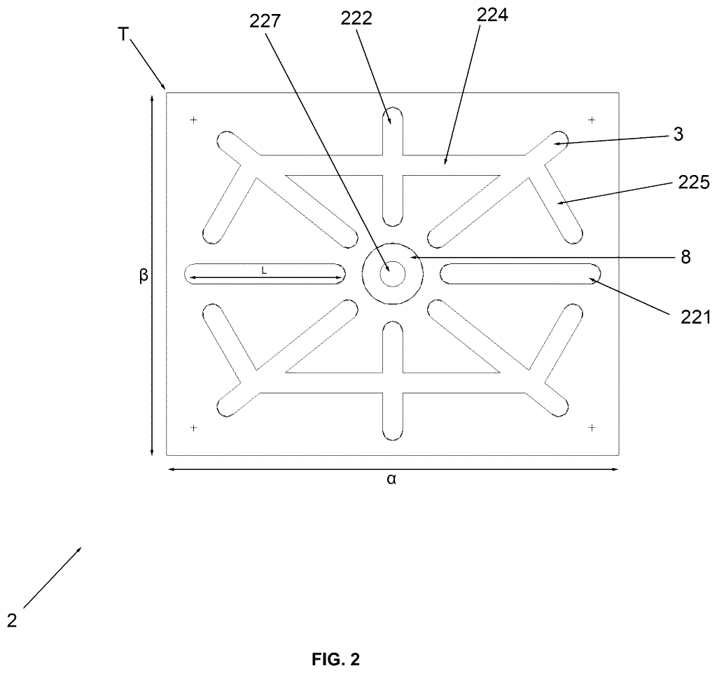

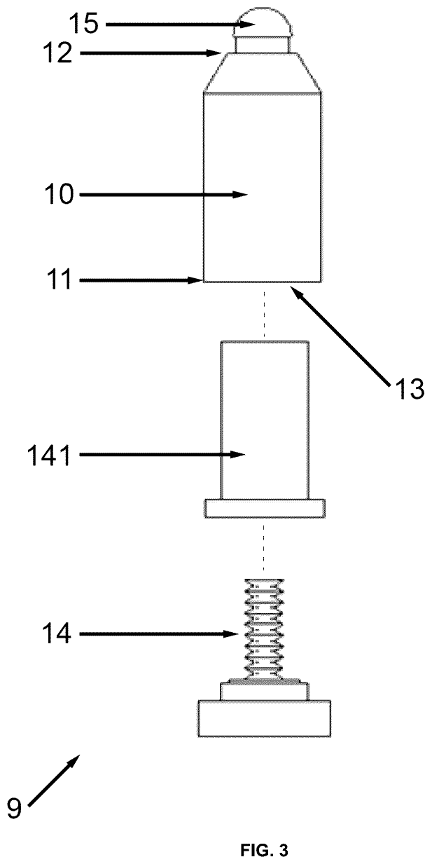

FIG. 1 depicts an embodiment of a portable evidence support stand 1. The evidence support stand 1 comprises a base plate 2. The base plate 2 comprises a thickness T extending between a depending surface 50 and a superior surface 51, wherein the base plate further comprises a plurality of mounting apertures 3 defined through the whole thickness of the base plate. In an embodiment, the apertures 3 comprise any shape suitable for receiving a support member 5. As shown in FIG. 1, the base plate 2 comprises a longitudinal axis α and a latitudinal axis β. In an embodiment, the support stand 1 comprises any number of mounting apertures, wherein the apertures comprise any shape suitable to receive a support member (9 shown in FIG. 3). Various configurations comprise apertures that are discrete, isolated from other apertures, the horizontal slots 221 shown in FIG. 2 and discussed below, for example. Additionally, in various embodiments, the apertures are joined by a channel 330.

As shown in FIG. 2 of a top view of an exemplary embodiment of a base plate 2, the plurality of mounting apertures 3 comprise slots or channels defined in the base plate 2. Said slots comprise voids extending through the entire thickness T of the base plate. Said slots have a length L and comprise a width between approximately 5.5 mm and approximately 6 mm. The number and orientation of said slots is customizable to the needs of the user. Said slots can be orientated in any direction desired by the user, where the orientation of each slot can be chosen individually. For example, the length L of the slots may extend in a direction parallel to the longitudinal axis α of the base plate, perpendicular to the longitudinal axis α of the base plate, and at any angle relative to the longitudinal axis of the base plate α.

As shown in FIG. 2, the exemplary embodiment shown in FIG. 2 comprises slots that extend radially from the center of the base plate 2 in eight directions: two horizontal slots 221, two vertical slots 222, and four slots at approximately 45 degree angles 3. In an embodiment, two additional horizontal slots 224 extend parallel to the horizontal slots 221 and intersect the vertical slots 222 and two 45 degree angle slots 3. In an embodiment, between each 45 degree angle slot 3 and horizontal slot 224, an about 60 degree slot 225 intersects the 45 degree slot 3 and extends towards, but not into the horizontal slot 221. A person having ordinary skill in the art will readily understand that this configuration of mounting apertures is exemplary and not meant to be limiting. Further, in an embodiment, the base plate 2 comprises an about 16 mm in diameter central recessed circular cutout 8 and a hole 227 to accommodate a bolt up to about 6 mm in diameter to secure the base plate 2 to a 3D scanning turntable, or any other surface that allows for a bolt connection, such that the bolt head will not be scanned as part of the 3D scanning process.

Returning to FIG. 1, the evidence support stand 1 comprises a plurality of support members 5, wherein each support member 5 comprises a bumper pad 6, and wherein each support member extends substantially perpendicularly from the base plate 2 and is secured to the base plate 2 by a fastener 4 extending through the base plate from its depending surface 50 through a mounting aperture 3. As shown in FIG. 3, an embodiment of an exemplary support member 9 comprises a body 10 with a first end 11 and a second end 12, wherein the first end 11 defines an aperture 13 therein configured to receive a fastener 14, and wherein the second end 12 comprises a bumper pad 15 thereon. In an embodiment, the support member has a diameter that tapers near its second end where it contacts the bumper pad. In an embodiment, the aperture 13 facilitates the addition of a rubber expansion nut or well nut 141 of the same shaft diameter as the fastener 14 therein.

Returning to FIG. 1, the evidence support stand 1 comprises a plurality of fasteners 4, wherein each fastener is configured to slide within a corresponding mounting aperture 3, wherein the fasteners slide in a direction parallel to the superior surface 51 of the base plate 2. In an embodiment, the plurality of fasteners 4 is selected from #10-32×1″ thumb screws, carriage bolts, hex bolts, machine bolts and combinations thereof. A person having ordinary skill in the art will readily understand that this list of fasteners is exemplary and not meant to be limiting.

Additionally, as shown in FIG. 3, in an embodiment, the bumper pad 15 comprises a material that is optically transparent to a 3D scanning beam, such that the bumper pad 15 does not topologically associate with the piece of forensic evidence during the 3D scanning process and thus reduces margin of error during a 3D scanning process. In an embodiment, the 3D scanning beam is a laser with a 3D point accuracy of about 0.05 mm from a 360 degree medical grade laser scanner used to create surgically accurate models. In an embodiment, the bumper pad 15 comprises a material that ensures that the piece of forensic evidence is balanced, gripped, and protected during the 3D scanning or examination process. In an embodiment, the bumper pad 15 comprises a material that can be sanitized easily and will not disintegrate with repeated introduction of alcohol or other disinfectants in between uses. In an embodiment, the bumper pad 15 material is selected from silicone, latex, foam, soft rubber, plastic, and combinations thereof. A person having ordinary skill in the art will readily understand that this list of bumper pad materials is exemplary and not meant to be limiting.

In embodiments, the support members 9 are cylindrical and comprise a range of first end 11 diameters from about 10 mm and about 15 mm, and preferably are about 13.5 mm. In embodiments, the support members 9 vary in height, and range between about 18 mm and about 26 mm, and preferably are about 21 mm. In embodiments, the diameter of the support member tapers toward its second end 12 such that the second end of the support member 9 defines a cone that tapers to about 8 mm in diameter with a flat surface upon which bumper pad 15 is attached. In embodiments, the bumper pad 15 comprises a diameter ranging from about 6.5 mm and about 8 mm, and preferably is about 6.7 mm and a height ranging from about 4 mm and about 8 mm and preferably is about 5.3 mm. In embodiments, the support members 9 are fixed in height. In alternate embodiments, the support members 9 comprise a height adjustment assembly.

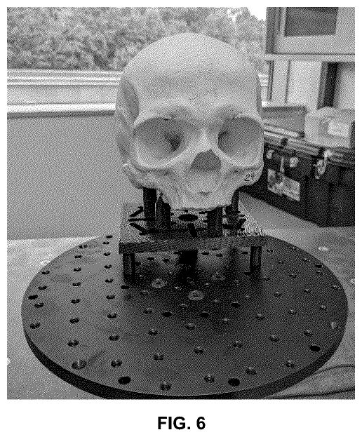

Returning to FIG. 1 (and as shown in FIG. 6), a salient feature of the invention is that, in an embodiment, the plurality of the support members 5 elevate a piece of forensic evidence from the base plate 2 enabling access to the underside of the piece of forensic evidence. In an embodiment, elevating the piece of forensic evidence allows the piece of forensic evidence to be scanned in one session without having to reposition or flip the piece of forensic evidence to scan its underside, thus reducing the margin of error during the 3D scanning process.

As shown in FIG. 1, the base plate 2 comprises a plurality of feet 7 extending from the depending surface 50 of the base plate 2. In an embodiment, the plurality of feet 7 comprise a leveling assembly, thus facilitating the use of the evidence support stand 1 on non-level surfaces or in situations when leveling is imperative for measurements. Further, in an embodiment, the base plate 2 comprises a coupler securing the base plate to a 3D scanning turntable or other surface without said coupler being scanned as part of the 3D scanning process. In an embodiment, said coupler securing the base plate 2 is selected from bolts, nuts, screws, magnets, adhesives, and combinations thereof. A person having ordinary skill in the art will readily understand that this list of couplers is exemplary and not meant to be limiting. In an embodiment, the base plate 2 comprises a central recessed circular cutout 8 with a hole therein to accommodate a bolt used to secure the base plate 2 to a 3D scanning turntable. In an alternative embodiment, the coupler securing the base plate 2 interfaces with the plurality of feet 7 and a 3D scanning turntable.

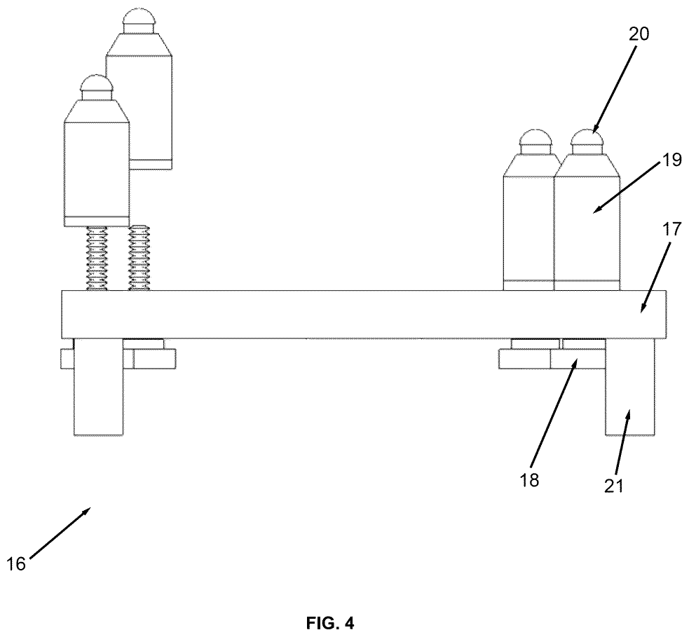

FIG. 4 depicts a side view of an embodiment of an evidence support stand 16. In an embodiment, the evidence support stand 16 comprises a base plate 17 and a plurality of feet 21. In an embodiment, a plurality of support members 19 featuring bumper pads 20 thereon are attached to the base plate 17 by a plurality of fasteners 18, wherein each fastener 18 is placed underneath the base plate 17 and extends through the base plate 17 via mounting apertures therethrough and into the support member 19 at the interface between the support member and the base plate. In an embodiment, the plurality of fasteners 18 are tightened to secure the plurality of support members 19 to the base plate 17.

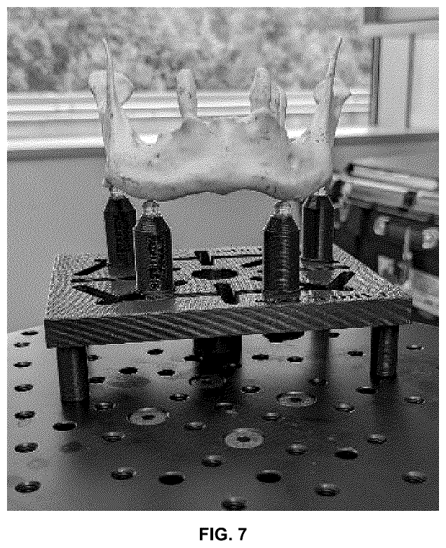

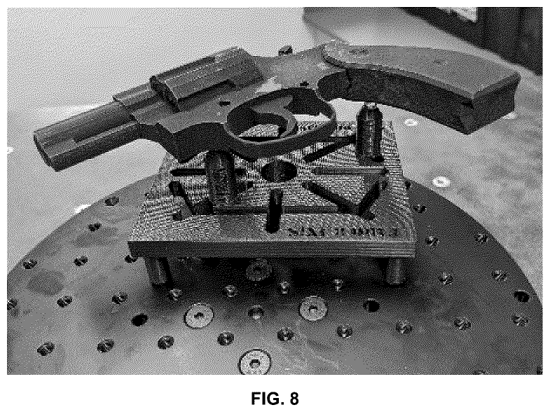

In embodiments, the positions of the plurality of support members 19 are each adjustable relative to the base plate 17 by sliding the corresponding fastener 18 in a direction parallel to the superior surface of the baseplate (51 in FIG. 1) within a corresponding mounting aperture in the base plate 17, thereby allowing the plurality of support members 19 to precisely accommodate and support different sizes of forensic evidence, as shown in FIGS. 6, 7, and 8. FIG. 6 is an exemplary embodiment of a portable repositioning evidence support stand in use supporting a human skull. FIG. 7 is an alternate exemplary embodiment of a portable repositioning evidence support stand in use supporting a mandible. FIG. 8 is a further alternate exemplary embodiment of a portable repositioning evidence support stand in use supporting a firearm.

In embodiments, the evidence support stand, including the base plate 17, plurality of fasteners 18, plurality of support members 19, plurality of bumper pads 20, and plurality of feet 21, comprise a material that can be sanitized easily and will not disintegrate with repeated introduction of alcohol or other disinfectants in between uses. In an embodiment, said material is selected from plastic, aluminum, latex, silicone, rubber, foam, and combinations thereof. A person having ordinary skill in the art will readily understand that this list of materials is exemplary and not meant to be limiting.

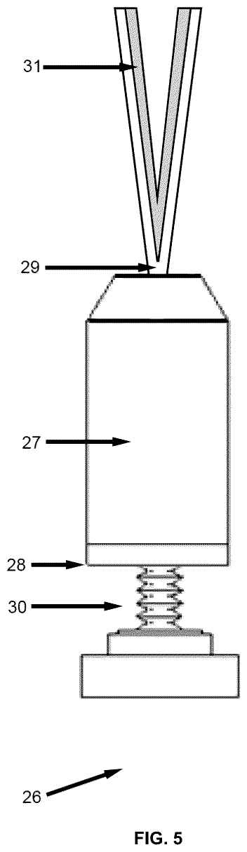

FIG. 5 depicts an alternate embodiment of a support member 26, which comprises a body 27 with a first end 28 with an aperture configured to receive a fastener 30 therein, and a second end 29 shaped as a “V” with a V-shaped bumper pad 31 thereon. In an embodiment, the V-shaped second end 29 accommodates support of alternate pieces of forensic evidence thereon, such as a knife blade. In an alternative embodiment, the second end of the support member comprises a “U” shape accommodating support of alternative pieces of forensic evidence thereon, such as a firearm barrel. A person having ordinary skill in the art will readily understand that this list of second end 29 shapes is exemplary and not meant to be limiting.

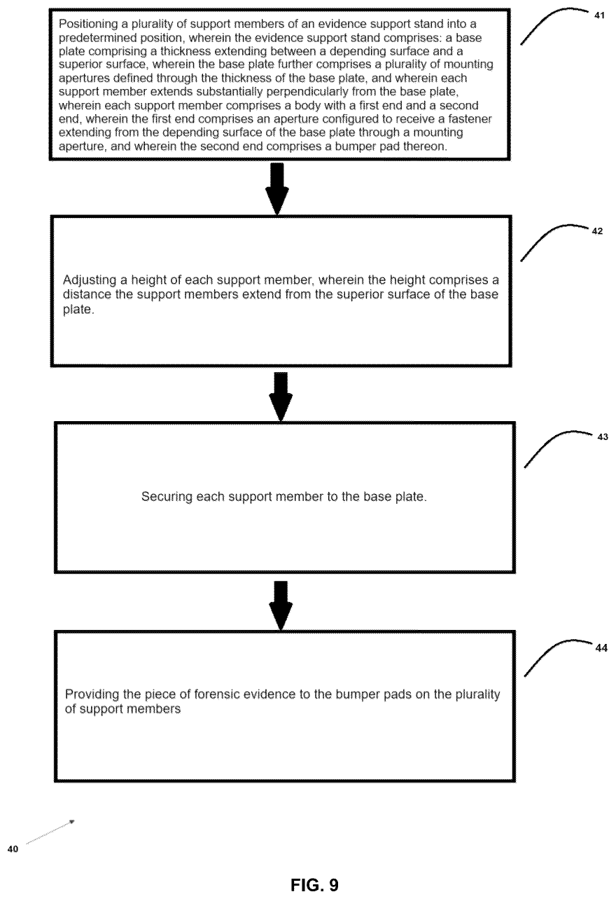

FIG. 9 depicts a flowchart for a method 40 for adjusting support of a piece of forensic evidence for 3D scanning using embodiments of the invented evidence stand described herein. The method 40 begins with positioning a plurality of support members of an evidence support stand into a predetermined position 41. In an embodiment, evidence support stand comprises a base plate, wherein the base plate comprises a thickness extending between a depending surface and a superior surface, wherein the base plate further comprises a plurality of mounting apertures defined through the whole thickness of the base plate. In an embodiment, each support member extends substantially perpendicularly from the base plate and each support member comprises a body with a first end and a second end, wherein the first end comprises an aperture configured to receive a fastener extending from the depending surface of the base plate through a mounting aperture, and wherein the second end comprises a bumper pad thereon. In an embodiment, the bumper pad comprises of a material optically transparent to a 3D scanning beam.

In an embodiment, positioning the plurality of support members enables precisely accommodating and supporting multiple sizes of pieces of forensic evidence. In an embodiment, the positions of the plurality of support members are each adjustable relative to the base plate by sliding a corresponding fastener within a corresponding mounting aperture, thereby allowing the plurality of support members to precisely accommodate and support different sizes of pieces of forensic evidence. In embodiments, the base plate comprises any number and orientation of mounting apertures. In embodiments, the mounting apertures comprise any shape suitable to receive a support member.

The method 40 continues with adjusting the height of each support member 42, wherein the height of a support member is the distance the support member extends from the superior surface of the base plate.

The method 40 continues with securing each support member to the base plate 43.

The method 40 continues with providing the piece of forensic evidence to the bumper pads of the plurality of support members 44. In an embodiment, the plurality of the support members elevates the piece of forensic evidence enabling access to the underside of the forensic evidence.

In some embodiments, the base plate of the evidence support stand further comprises a plurality of feet extending from the depending surface of the base plate. In some embodiments, the base plate of the evidence support stand further comprises a coupler securing the base plate to a 3D scanning turntable without said coupler being scanned as part of a 3D scanning process. In some embodiments, the base plate is secured to any other base that allows for bolt connections.

In some embodiments, the evidence support stand is used independently on a level or a non-level surface to support a piece of forensic evidence.

In some embodiments, the dimensions of the base plate of the evidence support stand is varied to accommodate different sizes of pieces of forensic evidence.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

What is claimed is:

1. An evidence support stand, the stand comprising:
a base plate comprising a thickness extending between a depending surface and a superior surface, wherein the base plate further comprises a plurality of mounting apertures defined through the thickness of the base plate;
a plurality of fasteners, each fastener configured to slide within a mounting aperture; and
a plurality of support members, wherein each support member extends substantially perpendicularly from the base plate, and wherein the support members are secured to the base plate by a fastener,
wherein the fastener extends through the base plate from its depending surface through a mounting aperture,
wherein the support members have a height comprising a distance the support members extend from the superior surface of the base plate, and wherein the positions of the support members are configured to be adjusted by sliding a fastener within a corresponding mounting aperture, thereby allowing the plurality of support members to precisely accommodate and support different sizes of pieces of forensic evidence.

2. The evidence support stand of claim 1 wherein the base plate comprises any number and orientation of mounting apertures.

3. The evidence support stand of claim 1 wherein the mounting apertures comprise any shape suitable to receive a support member.

4. The evidence support stand of claim 1 wherein the base plate further comprises a plurality of feet extending from the depending surface of the base plate.

5. The evidence support stand of claim 1 wherein the base plate further comprises a coupler securing the base plate to a 3D scanning turntable without said coupler being scanned as part of a 3D scanning process.

6. The evidence support stand of claim 1 wherein the support members each further comprise a body with a first end and a second end, wherein the first end defines an aperture therein configured to receive a fastener, and wherein the second end comprises a bumper pad thereon.

7. The evidence support stand of claim 6, wherein the bumper pad comprises a material optically transparent to a 3D scanning beam.

8. The evidence support stand of claim 1, wherein the plurality of the support members elevate a piece of forensic evidence enabling access to the underside of the piece of forensic evidence.

9. The evidence support stand of claim 1, wherein the evidence support stand comprises materials that are easily sanitized and will not disintegrate with repeated introduction to disinfectants.

10. A method for adjusting support of a piece of forensic evidence for 3D scanning, comprising:
positioning a plurality of support members of an evidence support stand into a predetermined position, wherein the evidence support stand comprises:
a base plate comprising a thickness extending between a depending surface and a superior surface, wherein the base plate further comprises a plurality of mounting apertures defined through the thickness of the base plate, and wherein each support member extends substantially perpendicularly from the base plate, wherein each support member comprises a body with a first end and a second end, wherein the first end comprises an aperture configured to receive a fastener extending from the depending surface of the base plate through a mounting aperture, and wherein the second end comprises a bumper pad thereon;
adjusting a height of each support member, wherein the height comprises a distance the support members extend from the superior surface of the base plate;
securing each support member to the base plate; and
providing the piece of forensic evidence to the bumper pads on the plurality of support members.

11. The method of claim 10, wherein the base plate comprises any number and orientation of mounting apertures.

12. The method of claim 10, wherein the mounting apertures comprise any shape suitable to receive a support member.

13. The method of claim 10, wherein the base plate further comprises a plurality of feet extending from the depending surface of the base plate.

14. The method of claim 10, wherein the base plate further comprises a coupler securing the base plate to a 3D scanning turntable without said coupler being scanned as part of a 3D scanning process.

15. The method of claim 10, wherein the bumper pads comprise a material optically transparent to a 3D scanning beam.

16. The method of claim 10, wherein the plurality of the support members elevate the piece of forensic evidence enabling access to the underside of the forensic evidence.

17. The method of claim 10, wherein moving the plurality of support members enables precisely accommodating and supporting multiple sizes of pieces of forensic evidence.
